(19) United States
(12) Patent Application Publication
(10) Pub. No.: US 2008/0190170 A1
(43) Pub. Date: Aug. 14, 2008

(54) Method and Device for Detecting Leaks in a Motor Vehicle Air Spring Arrangement

(75) Inventor: Alexander Stiller, Garbsen (DE)

Correspondence Address: CONTINENTAL TEVES, INC., ONE CONTINENTAL DRIVE, AUBURN HILLLS, MI, 48326-1581, US

(73) Assignee: Continental Aktiengesellschaft

(21) Appl. No.: 12/067,509

(22) PCT Filed: Aug. 28, 2006
(86) PCT No.: PCT/EP2006/065713

§ 371 Date: Mar. 20, 2008

(30) Foreign Application Priority Data
Sep. 22, 2005 (DE) 10 2005 045 269

(51) Int. Cl. G01M 17/04; G01F 22/02

(52) U.S. Cl. 73/11.07; 73/117.03; 73/149

(57) ABSTRACT

Disclosed is a method for detecting leaks in an air spring arrangement (1) in a motor vehicle, having a ride level control device which has a plurality of air springs (2a, 2b, 2c, 2d), devices (5a, 5b, 5c, 5d, 6, 12, 14a, 14b, 14c, 14d) for determining the total quantity of air in the air spring arrangement (1), and devices (15a, 15b, 15c, 15d, 16, 17) for sensing the temperature, and a device for carrying out the method. According to the invention, in the method there is provision that the total quantity of air Q₁ at a first time t₁ and the total quantity of air Q₂ at a second time t₂ are determined in the air spring arrangement (1) and are corrected by a temperature-dependent factor which is obtained by sensing the temperature of the air which is located in the air spring arrangement and forming the difference between the total quantities of air Q₁, Q₂, which have been temperature-corrected, so that when the difference is exceeded by a specific limiting value Qₗᵢₘᵢₜ a leak is detected in the air spring arrangement (1).

### BACKGROUND OF THE INVENTION

The present invention relates to a method for detecting leaks in a motor vehicle air spring arrangement comprising a level control device that has one or more air springs, devices for determining the total air quantity in the air spring arrangement, and devices for sensing temperature. The invention further relates to a device for carrying out such a method.

Air spring arrangements comprising level control devices are known in the most varied embodiments. For example DE 40 03 781 A1 discloses a device for level control for a vehicle with air springing in the case of which level and/or height signals sensed by height sensors are filtered with the aid of a time constant in order to improve the control response of the device. A height change of an air spring is either occasioned by a load change or caused by a leak in the air spring.

For the purpose of distinguishing in the case of control processes whether a control request is being made on the basis of a changed load condition or on the basis of a leak, DE 103 00 737 A1 describes a method for detecting leaks in a motor vehicle air spring arrangement comprising a level control device in the case of which an electronic control unit is processed sensor signals that are received by height sensors, assigned to the individual air springs, with the aid of at least one pressure sensor, for the purpose of controlling the air spring valves and a compressor for raising and lowering the vehicle.

To this end, the height difference values of the corresponding air springs and the associated air pressures are measured at a first instant, and their height difference values and, if appropriate the air pressures in the corresponding air springs are determined at a second, later instant. A leak is detected in the case of an air spring whenever the corresponding pressure has been reduced at a second instant and the height associated with the air spring has decreased.

The fluctuation in the pressure values of the air quantity enclosed in the arrangement owing to changes in the temperature of the air quantity that can be caused by changes in state of the air and/or by variations in ambient temperature is not considered. Consequently, a leak of an air spring can be unjustifiably identified when the air in the air spring cools strongly. Furthermore a pressure loss owing to a leak can be compensated by a heating of the air. Consequently, the leak is not detected until the compensation by the heating can no longer balance out the pressure loss.

DE 101 60 972 C1 describes a method for the regulation of the air quantity in a closed pneumatic level control system of a motor vehicle that can be filled and emptied. A temperature sensor for measuring the ambient temperature that is evaluated for the regulation is arranged on the vehicle. The air mass of a system is calculated from the air pressures in the individual components, for the vehicle level and from the ambient temperature and used for level control.

It is problematic in this case that the ambient temperature does not necessarily correspond to the air temperature in the system. Not until a thermic transition of the heat does an adaptation of the air temperature take place in conjunction with a changed ambient temperature. In addition, the air contained in the system is subjected to a continuous temperature fluctuation owing to dynamics of the air spring.

It is therefore the object of the present invention to enable a reliable detection of leaks in a motor vehicle air spring arrangement.

### SUMMARY OF THE INVENTION

In the case of a method of the type designated above, it is provided according to the invention that the total air quantity Q₁ in the air spring arrangement is determined at a first instant t₁ and the total air quantity Q₂ in the air spring arrangement is determined at a second instant t₂, these quantities being corrected by a temperature dependent factor that results from sensing of the temperature of the air present in the air spring arrangement, and the difference between the temperature corrected total air quantities Q₁, Q₂ is formed such that a leak in the air spring arrangement is identified upon overshooting of the difference by a specific limiting value Q_{Grenz}.

It is preferably the case that measured values of at least one pressure sensor and at least one height sensor are evaluated when determining the total air quantities Q₁, Q₂. The volume available to the air quantity can be determined from the value of the height measurement with the aid of the cross section of the air spring as defined by design.

In an advantageous way, the total air quantities Q₁, Q₂ of the air spring arrangement are determined from the sum of the air quantities in the individual air springs and the air quantity in an air chamber and in air lines that connect the air chamber to the air springs.

In order to avoid faults owing to level control processes, it is advantageous that when forming the difference consideration is given to an air quantity Qᵢₙ fed from outside to the air spring arrangement and/or to an air quantity Qₐᵤₛ released into the surroundings.

The method in accordance with the invention is advantageously carried out with a motor vehicle stationary. Likewise advantageously, the method according to the invention is carried out when the motor vehicle is closed. It is possible in this way to avoid measuring errors owing to the driving dynamics or to varying load conditions.

An advantageous refinement provides that upon detection of a leak a warning signal is generated and transferred to a driver of the motor vehicle. This can be performed by an acoustic and/or visual display in the vehicle interior. The driver is directly advised of the state of the level control system and can carry out appropriate safety relevant steps, for example a slowing down of the driving.

It is likewise advantageously provided that upon detection of a leak an appropriate fault message is stored in a diagnosis storage device, in order to make this detected fault available for later purposes of analysis and repair.

Finally, an advantageous embodiment of the method according to the invention provides that upon detection of a leak the level control device initiates an emergency run that transfers the motor vehicle to a level position uncritical for the driving dynamics.

In addition to a motor vehicle air spring arrangement comprising a level control device that has one or more air springs, devices for determining the total air quantity in the air spring arrangement, and devices for sensing temperature, a device for carrying out the method in accordance with the present invention further has an evaluation/control device that is designed to form a difference from two total air quantities Q₁, Q₂ determined at different instants t₁, t₂ and corrected by a temperature dependent factor that results from the sensing of the temperature of the air present in the air spring arrangement, and to identify a leak in the air spring arrangement upon overshooting of the difference by a specific limiting value Q_{Grenz}.

The invention is explained more closely by way of example below with the aid of the detailed description and with reference to the attached drawings, in which:

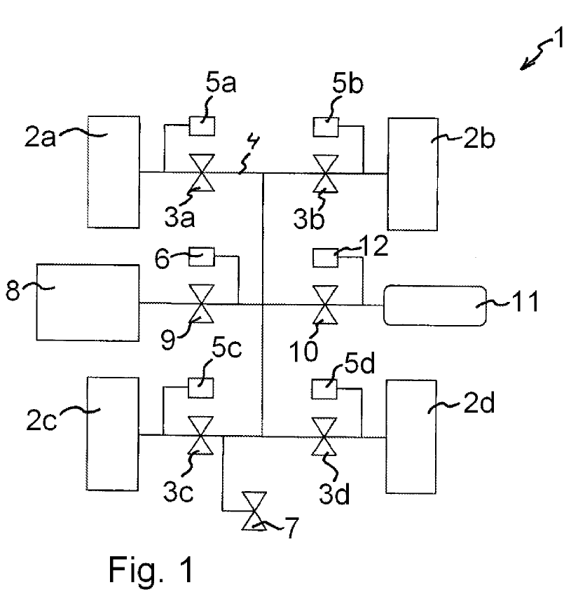

FIG. 1 shows a block diagram of a motor vehicle air spring arrangement; and

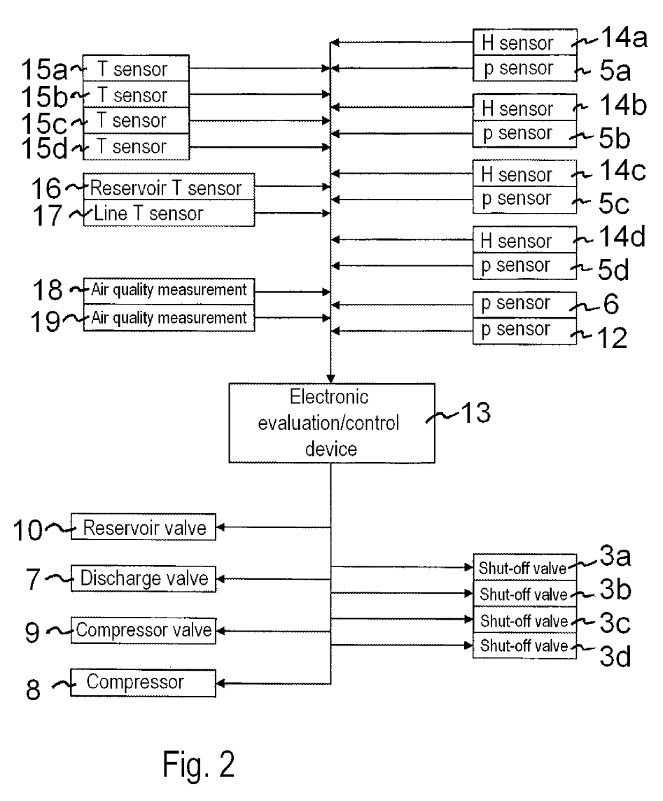

FIG. 2 shows a schematic block diagram for controlling an exemplary embodiment.

FIG. 1 shows a schematic sketch of a motor vehicle air spring arrangement 1 that has a total of four air springs 2a, 2b, 2c, 2d that are assigned four motor vehicle wheels for supporting the motor vehicle frame. It is clear that the number of the air springs 2a, 2b, 2c, 2d is selected merely by way of example and can be any desired number.

Likewise, the method can also be applied to other pneumatic supply systems, for example a closed supply system.

The individual air springs 2a, 2b, 2c, 2d are connected via in each case one shut-off valve 3a, 3b, 3c, 3d to a pressure line system 4. Each of the air springs 2a 2b 2c 2d is assigned a pressure sensor 5a, 5b, 5c, 5d in order to determine the air pressure inside the respective air spring 2a, 2b, 2c, 2d. Furthermore, each air spring 2a, 2b, 2c, 2d is assigned a height sensor (not illustrated) whose signals are evaluated by a level control device (not illustrated).

Likewise arranged on the pressure line system 4 is a pressure sensor 6 for measuring the air pressure present in the pressure line system 4. Furthermore, a discharge valve 7 is provided on the pressure line system 4 in order to release air into the surroundings from the air spring arrangement 1. A compressor 8 that is connected to the pressure line system 4 via a compressor valve 9 is provided in order to feed air from the surroundings into the air spring arrangement 1. Finally, the air spring arrangement 1 has a compressed air reservoir 11 that is connected to a shut-off valve, denoted as reservoir valve 10 and whose internal pressure can be determined via a reservoir pressure sensor 12.

The total volume of the air spring arrangement is thus composed of the partial volumes of the individual air springs 2a, 2b, 2c, 2d, the compressed air reservoir 11 and the pressure line system 4. Each of these partial volumes is assigned a compressed air sensor 5a, 5b, 5c, 5d, 6, 12 for determining the air pressure in this partial volume.

FIG. 2 shows a schematic block diagram for controlling a first exemplary embodiment of the inventive air spring arrangement 1 from FIG. 1. An essential element is an electronic evaluation/control device 13 that receives and evaluates signals from the sensors distributed in the system. The electronic control device 13 controls the multiplicity of the valves and the compressor 8 in accordance with the evaluation.

The electronic control device 13 receives from each of the air springs, 2a, 2b, 2c, 2d (FIG. 1) a pressure value determined by the assigned pressure sensors 5a, 5b, 5c, 5d and, in each case, a signal of a height sensor 14a, 14b, 14c, 14d assigned to each air spring 2a, 2b, 2c, 2d. The electronic control device 13 can determine the volumes of the air springs 2a, 2b, 2c, 2d from the signals of the height sensors 14a, 14b, 14c, 14d and from the cross section of the air springs 2a, 2b, 2c, 2d, which is defined by design. The volumes of the compressed air line 4 and the compressed reservoir 11 are likewise defined by design and are not variable.

The product of volume and pressure is constant for a given, ideal amount of gas given a temperature that remains constant (Boyle's law). Furthermore it holds for a given quantity of gas at a constant volume that the quotient of pressure and temperature remains the same (Charles's law). Both laws are special cases of the equation of state of the ideal gases, and can be combined in the following way for two states:

$$\frac{{p}_{1} {V}_{1}}{{T}_{1}} = \frac{{p}_{2} {V}_{2}}{{T}_{2}}$$

This relationship is valid only approximately for air as a real gas. This can be detected, however, since the deviation is of the order of magnitude of the measuring accuracy. Since it holds for the quantities of air that:

$${Q}_{1} ∼ \frac{{p}_{1} \cdot {V}_{1}}{{T}_{1}}$$

$${Q}_{2} ∼ \frac{{p}_{2} \cdot {V}_{2}}{{T}_{2}} ,$$

a leak of the components comprising air spring, reservoir or line can be detected when the following equation is satisfied:

$$( \frac{{p}_{1} \cdot {V}_{1}}{{T}_{1}} ) - ( \frac{{p}_{2} \cdot {V}_{2}}{{T}_{2}} ) \geq {Q}_{Grenz}$$

Since the total air quantity is yielded from the sum of the partial air quantities, the following condition is valid for the detection of leaks:

$$\frac{{p}_{1 a} \cdot {V}_{1 a}}{{T}_{1 a}} + \frac{{p}_{1 b} \cdot {V}_{1 b}}{{T}_{1 b}} + \frac{{p}_{1 c} \cdot {V}_{1 c}}{{T}_{1 c}} + \frac{{p}_{1 d} \cdot {V}_{1 d}}{{T}_{1 d}} + \frac{{p}_{1 Speicher} \cdot {V}_{1 Speicher}}{{T}_{1 Speicher}} + \frac{{p}_{1 Leitung} \cdot {V}_{1 Leitung}}{{T}_{1 Leitung}} - \frac{{p}_{2 a} \cdot {V}_{2 a}}{{T}_{2 a}} - \frac{{p}_{2 b} \cdot {V}_{2 b}}{{T}_{2 b}} - \frac{{p}_{2 c} \cdot {V}_{2 c}}{{T}_{2 c}} - \frac{{p}_{2 d} \cdot {V}_{2 d}}{{T}_{2 d}} - \frac{{p}_{2 Speicher} \cdot {V}_{2 Speicher}}{{T}_{2 Speicher}} - \frac{{p}_{2 Leitung} \cdot {V}_{2 Leitung}}{{T}_{2 Leitung}} \geq {Q}_{Grenz}$$

In order to detect a leak in the air spring arrangement 1 (FIG. 1) in accordance with the invention, the electronic evaluation/control device 13 additionally evaluates temperature signals that receives from temperature sensors 15a, 15b, 15c, 15d assigned to the individual air springs 2a, 2b, 2c, 2d, a reservoir temperature sensor 16 assigned to the compressed air reservoir 11, and a line temperature sensor 17 assigned to the pressure line system 4. Thus, sensor values for determining the current temperature and the current volume are assigned to each of the partial volumes of the air spring arrangement 1.

At a first instant t₁ the electronic evaluation/control device 13 now determines for each partial volume the air quantity that can be derived from the sensor values with the aid of the above relationships. When summed, the partial air quantities yield the total air quantity Q₁ of the air spring arrangement 1 at the instant t₁. The total air quantity Q₂ is determined anew at a second, later instant t₂. A leak in the air spring arrangement 1 is detected if the difference between the total air quantity Q₁ at the instant t₁ and the total air quantity Q₂ at the instant t₂ exceeds a prescribed limiting value Q_{Grenz}.

Alternatively, a counter can be incremented upon overshooting of the difference such that no leak is determined until a counter limiting value is overshot by the counter value at least one more time. The difference between the two instants t₁, t₂ is typically between 5 minutes and up to 5 hours.

Ideally, the above described leak detection functions reliably when the air quantity enclosed in the air spring arrangement 1 has not intentionally been varied by a release into the surroundings or by feeding with the aid of the compressor 8. However, in order also to enable the detection of leaks in the case of a desired variation in the enclosed total air quantity, additional consideration is given to the released air quantity Qₐᵤₛ and/or to the newly added air quantity Qᵢₙ when forming the difference. The following condition then holds for the detection of leaks:

$$( \frac{{p}_{1} \cdot {V}_{1}}{{T}_{1}} ) - ( \frac{{p}_{2} \cdot {V}_{2}}{{T}_{2}} ) - {Q}_{in} + {Q}_{aus} \geq {Q}_{Grenz}$$

In order to be able to consider the air quantities Qᵢₙ and Qₐᵤₛ when forming a difference, it is necessary to determine them in a suitable way. This can be performed, for example, by appropriate flow counters or other suitable sensors. Consequently, an air quantity measuring device 18 for the air quantity Qₐᵤₛ, and an air quantity measuring device 19 for the air quantity Qᵢₙ are provided in the block diagram.

When a shut-off valve 3a, 3b, 3c, 3d has not been opened between the two instants t₁ and t₂, that is to say no exchange of air has taken place between the air springs 2a, 2b, 2c, 2d and the pressure line system, a check for leaks can be carried out for these individual air springs 2a, 2b, 2c, 2d. It is possible in this way to assign a leak in the air spring arrangement 1 to a specific air spring 2a, 2b, 2c, 2d.

Measuring errors in temperature sensing can be avoided when the motor vehicle is not exposed to short term fluctuations in the ambient temperature and temperature fluctuations inside the air springs 2a, 2b, 2c, 2d and avoided by stopping the vehicle. A leak can be detected on the basis of the difference between the total air quantities Q₁, Q₂ corrected as a function of temperature, and, for example be passed on to the vehicle driver and/or workshop staff with a diagnostic interface.

Furthermore, a device having a pressure sensor 6 can be used to save on pressure sensors. The pressures in the individual components can then be determined by opening the associated valve. Determining the total air quantity then requires the air quantity volumes to be determined consecutively by switching the appropriate valves.

1-10. (canceled)

11. A method for detecting leaks in a motor vehicle air spring arrangement comprising a level control device that has one or more air springs, devices for determining the total air quantity in the air spring arrangement, and devices for sensing temperature, comprising the steps of
determining the total air quantity in the air spring arrangement at a first time t₁,
determining the total air quantity in the air spring arrangement at a second time t₂,
sensing the temperature of the air present in the air spring arrangement
correcting the total air quantities by a temperature-dependent factor that results from the sensed temperature resulting in a first and a second temperature-corrected total air quantity Q₁, Q₂,
calculating the difference between the first and the second temperature-corrected total air quantities Q₁, Q₂,
identifying a leak in the air spring arrangement if the difference exceeds a limiting value Q_{Grenz}, and
generating output information representive of the presence of a leak.

12. The method as claimed in claim 1, wherein the two total air quantities are determined by measuring at least a pressure and a height.

13. The method as claimed in claim 11, wherein the total air quantities are determined from the sum of air quantities in individual air springs and the air quantity in an air chamber and in air lines connecting the air chamber to the air springs.

14. The method as claimed in claim 11, further comprising the intermediate step of adding a value representing an air quantity Qᵢₙ fed from outside to the air spring arrangement and subtracting a value representing an air quantity Qₐᵤₛ released from the air spring arrangement from the calculated difference of air quantities before identifying a leak.

15. The method as claimed in claim 11, wherein the method is carried out when the vehicle is stationary.

16. The method as claimed in claim 11, wherein the method is carried out when the motor vehicle is locked.

17. The method as claimed in claim 11, wherein the output information representive of the presence of a leak is a warning signal to a driver of the motor vehicle.

18. The method as claimed in claim 11, including the further step of storing a fault message in a diagnosis storage device when the output information representive of the presence of a leak is generated.

19. The method as claimed in claim 11, including the subsequent step of initiating and emergency run of the level control device to elevate the vehicle to a position uncritical for driving dynamics.

20. A system comprising a a motor vehicle air spring arrangement (1) and a level control device with a number of air springs (2a, 2b, 2c, 2d), devices (5a, 5b, 5c, 5d, 6, 12, 14a, 14b, 14c, 14d) for determining the total air quantity in the air spring arrangement (1), and devices (15a, 15b, 15c, 15d, 16, 17) for sensing temperature, wherein an evaluation/control device (13) is designed to form a difference from two total air quantities determined at different instants t₁, t₂ and corrected by a temperature dependent factor resulting from sensing of the temperature of the air present in the air spring arrangement, and for identifying a leak in the air spring arrangement (1) if the difference exceeds a limiting value Q_{Grenz}.
